(19) United States
(12) Patent Application Publication
(10) Pub. No.: US 2006/0249600 A1
(43) Pub. Date: Nov. 9, 2006

(54) Fluid injection nozzle

(75) Inventors: Takaharu Sako, Toyoake-city (JP); Naofumi Adachi, Takahama-city (JP); Yoshiro Shogaki, Yokkaichi-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/410,007

(22) Filed: Apr. 25, 2006

(30) Foreign Application Priority Data
Apr. 26, 2005 (JP) 2005-128284

(51) Int. Cl. F02M 61/00

(52) U.S. Cl. 239/533.12; 239/96; 239/88; 239/585.1; 239/533.9

(57) ABSTRACT

In a fluid injection nozzle, a leading end portion of a needle is provided with a first conical surface, a second conical surface and a notch. A seat line between the first and second conical surfaces comes in contact with a seat surface. A gap between the first conical surface and the seat surface gradually narrowed as going downstream, and a gap between the second conical surface and the seat surface gradually widened as going downstream. The notch extends from an upstream end of the first conical surface to a side opposite from the second conical surface to face the seat surface.

### CROSS REFERENCE TO RELATED APPLICATION

This application is based upon and claims the benefit of priority of Japanese Patent Application No. 2005-128284 filed on Apr. 26, 2005, the content of which is incorporated herein by reference.

### FIELD OF THE INVENTION

The present invention relates to a fluid injection nozzle for injecting fluid such as fuel into a cylinder of an internal combustion engine, etc.

### BACKGROUND OF THE INVENTION

FIG. 6 depicts an example of a fuel injection nozzle that is incorporated in an injector for a common rail of a diesel engine (refer to JP-2004-27955-A).

The fuel injection nozzle is formed from a nozzle body 100 and a needle 110.

The nozzle body 100 has a guide hole 120 that houses the needle 110. A conical seat surface 130 is formed on a lower end portion of the guide hole 120. Further, a sac chamber 140 is hollowed at a downstream side of the seat surface 130. An injection hole 150 opens on an inner circumferential surface of the sac chamber 140.

The needle 110 is provided at a leading end portion thereof with a first conical surface 160 and a second conical surface 170, cone angles of which are different from each other, and has a seat line 180 on a boundary line (ridge line) on which the first conical surface 160 and the second conical surface 170 intersect with each other. The seat line 180 seats on the seat surface 130 in a valve-closing time of the needle 110, to interrupt a communication between the injection hole 150 and a fuel passage 190.

FIG. 7 depicts an example of an injector that uses the fuel injection nozzle.

The injector is provided with a control piston 200 that moves integrally with the needle 110, a control chamber 210 that is formed above the control piston 200, an electromagnetic valve 220 that opens and closes an outlet communicated with a low-pressure side of the control chamber 210, etc.

In the above-mentioned injector, a hydraulic force acting on a lower surface of the needle 110 ((Hydraulic force)×(Pressure-receiving area of needle 110)) acts as a valve-opening force F1 to push up the needle 110 to a valve-opening side, and a hydraulic force in control chamber 210 acting on an upper end surface of the control piston 200 ((Hydraulic force)×(Pressure-receiving area of control piston 200)) and a spring force urging the needle 110 act as a valve-closing force F2 to push the needle 110 to a valve-closing side. When the outlet of control chamber 210 is opened by the electromagnetic valve 220, the fuel in the control chamber 210 flows out to the low-pressure side to decrease the valve-closing force acting on the needle 110. Thus, when the valve-opening force F1 exceeds the valve-closing force F2, the needle 110 lifts up, so that the fuel is injected from the injection hole 150.

Currently, it is desired to increase a fuel injection pressure in injectors for common rail from the viewpoint of an improvement of an output power of diesel engines. However, when the fuel injection pressure is increased, an excessive force acts on a seat portion of the fuel injection nozzle (a portion in which the seat line 180 seats on the seat surface 130), so that the seat portion wears during use and the hydraulic force acting on the lower surface of the needle 100 increases just after an injection start. As a result, a lifting speed of the needle 110 increases, to cause an issue, as shown in FIG. 8, that an injection ratio after abrasion (shown by a solid line) is changed from an initial injection ratio (shown by a broken line).

### SUMMARY OF THE INVENTION

The present invention is achieved based on the above-described issues, and has an object to provide a fuel injection nozzle that can limit a change of an injection rate due to an abrasion of a seat portion, by increasing a hydraulic force that urges a needle to its lifting side.

The fuel injection nozzle has a nozzle body and a needle. The nozzle body has a guide hole therein to extend in an axial direction thereof, a seat surface formed in a conical shape on a leading end portion of the guide hole, a sac chamber formed at a downstream side of the sac chamber and an injection hole opened to the sac chamber. The needle is slidably inserted in the guide hole to open and close the injection hole.

A leading end portion of the needle is provided with a first conical surface, a second conical surface and a notch. The first conical surface and the second conical surface form a seat line therebetween, which comes in contact with the seat surface when the needle closes the injection hole. A gap between the first conical surface and the seat surface is gradually narrowed as going toward the injection hole. A gap between the second conical surface and the seat surface is gradually widened as going toward the injection hole. The notch extends in the axial direction from an upstream end of the first conical surface to a side opposite from the second conical surface to face the seat surface.

### BRIEF DESCRIPTION OF THE DRAWINGS

Features and advantages of embodiments will be appreciated, as well as methods of operation and the function of the related parts, from a study of the following detailed description, the appended claims, and the drawings, all of which form a part of this application. In the drawings:

FIG. 1 is an enlarged cross-sectional view showing a leading end portion of a fluid injection nozzle according to a first embodiment of the present invention;

FIG. 2 is an overall cross-sectional view of the fluid injection nozzle according to the first embodiment;

FIG. 3 is an overall cross-sectional view of an injector that incorporates the fluid injection nozzle according to the present invention;

FIG. 4 is an enlarged cross-sectional view showing a leading end portion of a fluid injection nozzle according to a second embodiment of the present invention;

FIG. 5 is an enlarged cross-sectional view showing a leading end portion of the fluid injection nozzle according to the second embodiment;

FIG. 6 is an enlarged cross-sectional view showing a leading end portion of a conventional fluid injection nozzle;

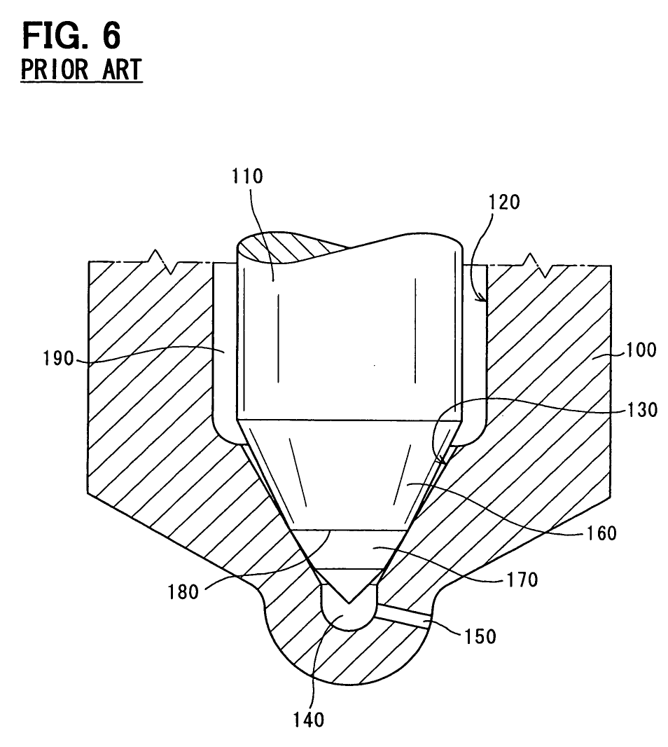

FIG. 7 is an overall cross-sectional view of an injector that incorporates the conventional fluid injection nozzle; and

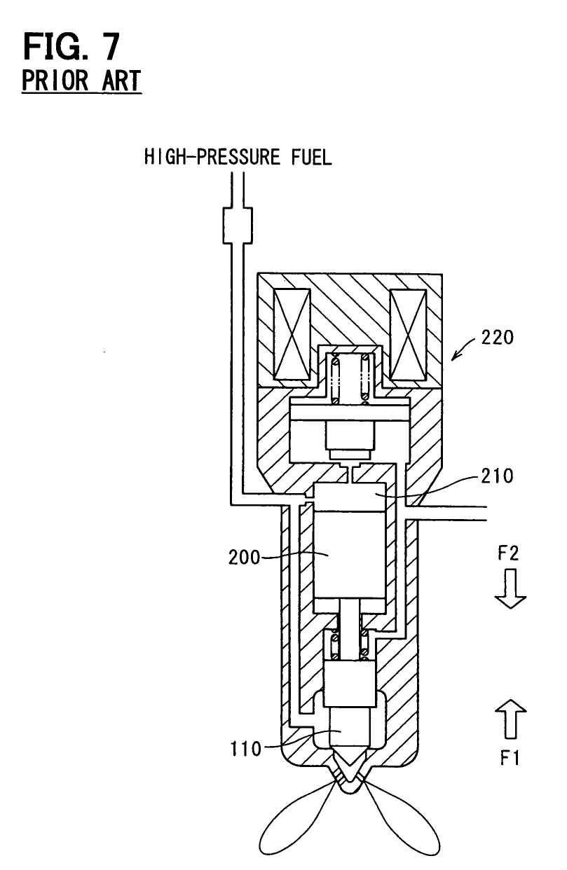

FIG. 8 is a waveform diagram showing a variation of an injection rate in accordance with an abrasion of a seat portion in a conventional fluid injection nozzle.

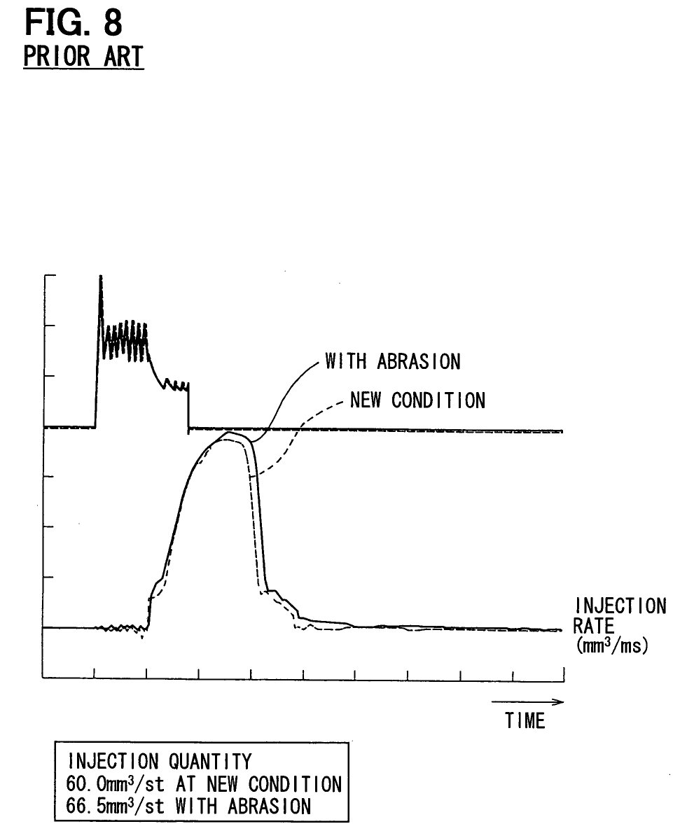

### DETAILED DESCRIPTION OF PREFERRED EMBODIMENTS

### First Embodiment

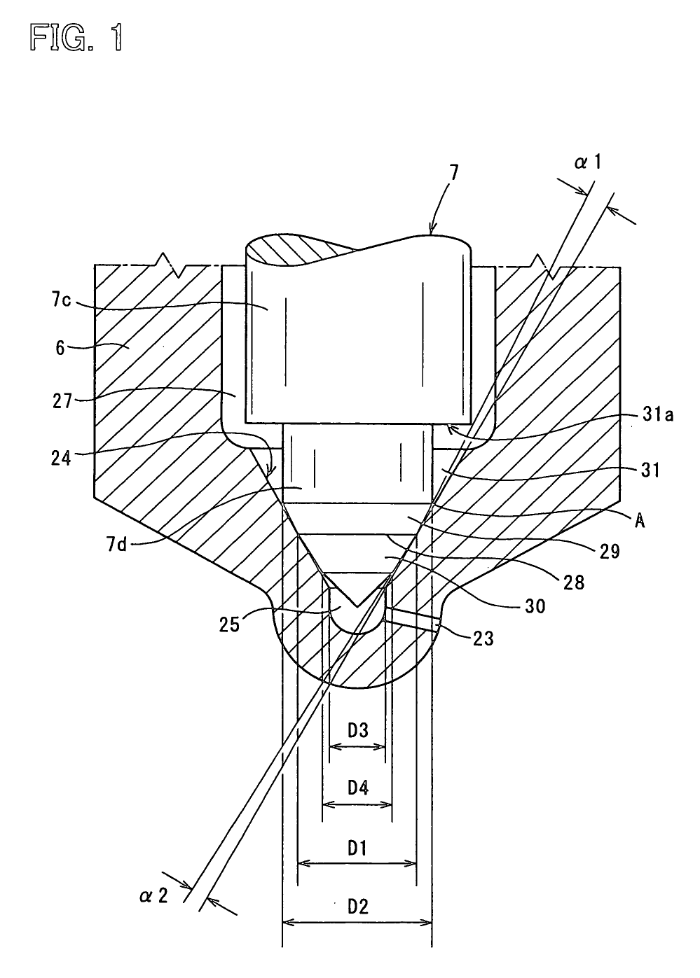

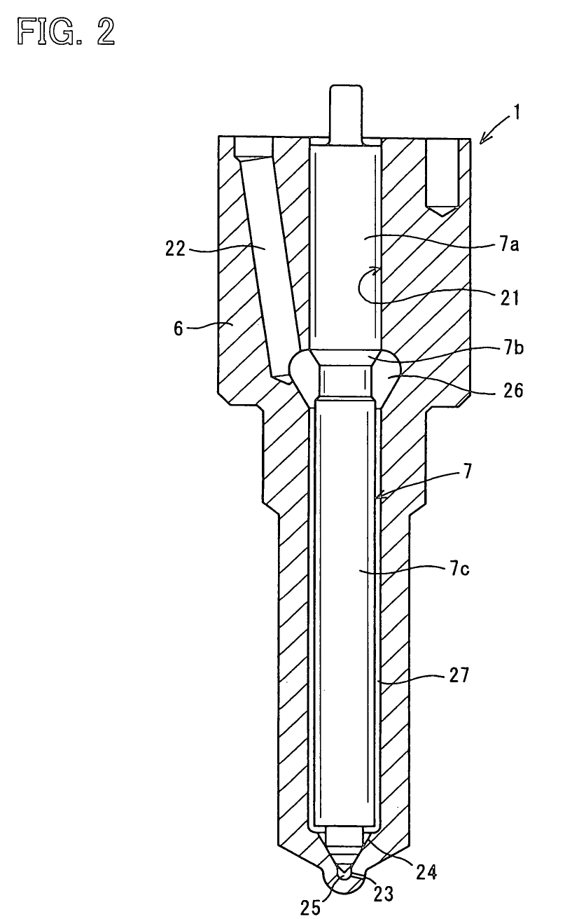

FIG. 1 is an enlarged cross-sectional view showing a leading end portion of a fuel injection nozzle 1. FIG. 2 is an overall cross-sectional view of the fuel injection nozzle 1.

The fuel injection nozzle (referred to as nozzle 1 in the following) according to the first embodiment is used to be attached to an injector 2 for a common rail for diesel engine, for example.

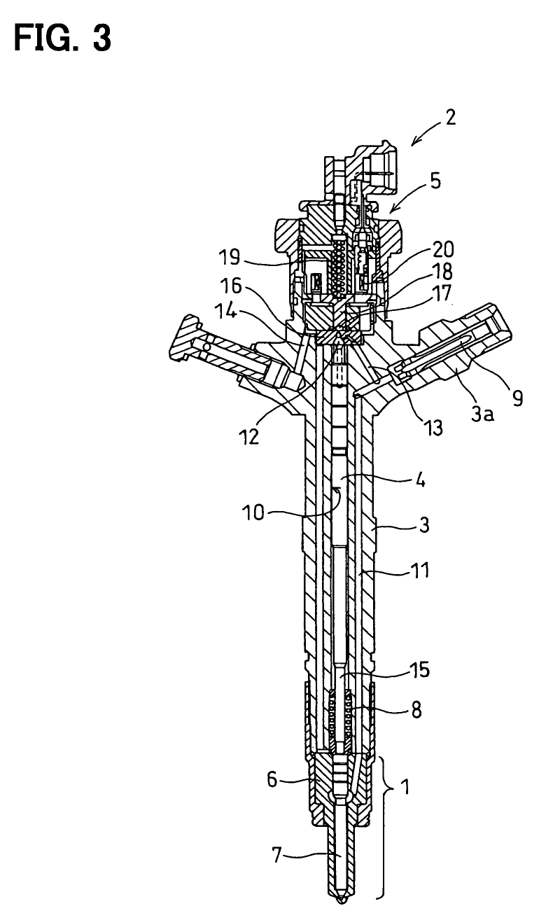

Firstly, a construction of the injector 2 is described based on FIG. 3.

The injector 2 is formed from the nozzle 1 according to the present invention, a nozzle holder 3 a control piston 4, an electromagnetic valve 5, etc.

The nozzle 1 is formed from a nozzle body 6 and a needle 7 that is inserted in the nozzle body 6. The needle 7 receives a load of a spring 8, which is housed in the nozzle holder 3, to be urged to a valve-closing side (downward in FIG. 3).

The nozzle holder 3 is provided with a pipe joint 3a, and supplied with high-pressure fuel from a common rail via a fuel pipe (not shown) that is connected to the pipe joint 3a. A bar filter 9 is housed in the pipe joint 3a to remove foreign matters contained in the fuel.

A cylindrical hole 10 that houses the control piston 4, a fuel passage 11 that leads high-pressure fuel supplied from the common rail to the nozzle 1, a fuel passage 13 that leads the high-pressure fuel to a control chamber 12 formed above the control piston 4, a discharge passage 14 that discharges surplus fuel, etc. are provided in the nozzle holder 3.

The control piston 4 is slidably inserted in a cylindrical hole 10 of the nozzle holder 3, so that a fuel pressure in the control chamber 12 acts onto an upper end surface of the control piston 4 to urge the control piston 4 downward in the drawing. A pressure pin 15 is integrally provided at a counter control chamber side of the control piston 4. A lower end surface of the pressure pin 15 is in contact with an upper end surface of the needle 7.

The control chamber 12 is communicated via an inlet orifice, which is provided in the orifice plate 16, with the fuel passage 13, and with an outlet orifice, which is provided in the orifice plate 16. The orifice plate 16 is located on an upper end portion of the nozzle holder 3, to be interposed between the nozzle holder 3 and the electromagnetic valve 5.

The electromagnetic valve 5 is formed from a valve element 17 that opens and closes the outlet orifice, an armature 18 that holds the valve element 17, a spring 19 that urges the armature 18 to a side in which the valve element 17 closes the outlet orifice (downward in the drawing), a solenoid 20 that drives the armature 18 by an electromagnetic force, etc.

When the solenoid 20 is turned off, the armature 18 is urged by the spring 19 and the valve element 17 is pushed onto the upper end surface of the orifice plate 16, so that the electromagnetic valve 5 closes the outlet orifice. When the solenoid 20 is energized, the armature 18 is attracted upward in the drawing against the urging force of the spring 19, so that the valve element 17 lifts off the upper end surface of the orifice plate 16 to open the outlet orifice.

Next, the nozzle 1 according to the first embodiment is described in detail in the following.

As shown in FIG. 2, a guide hole 21 that houses the needle 7, a fuel passage 22 that leads the fuel to the guide hole 21, an injection hole 23 that injects the fuel at a lift time of the needle 7, etc. are formed in the nozzle body 6.

The guide hole 21 is bored from an upper end surface of the nozzle body 6 toward a leading end portion of the nozzle body 6. A conical seat surface 24 is formed on a leading end portion of the guide hole 21. Further, a sac chamber 25 is formed at a downstream side of the seat surface 24. A fuel accumulation chamber 26 is formed on the way of the guide hole 21.

An upstream end of the fuel passage 22 opens on the upper end surface of the nozzle body 6 to be connected to the fuel passage 11 that opens on a lower end surface of the nozzle holder 3 (refer to FIG. 3). A downstream end of the fuel passage 22 is connected to the fuel accumulation chamber 26.

As shown in FIG. 1, the injection hole 23 is provided to penetrate a leading end wall portion of the nozzle body 6 that forms a surrounding of the sac chamber 25. An inlet (upstream side opening portion) of the injection hole 23 opens on an inner circumference of the sac chamber 25, and an outlet (downstream side opening portion) opens on an outer circumferential surface of the leading end wall portion.

The needle 7 is provided with a sliding portion 7a that is slidably inserted in the guide hole 21 in a portion upper than the fuel accumulation chamber 26, a pressure-receiving portion 7b that receives a fuel pressure in the fuel accumulation chamber 26, a shaft portion 7c that is inserted in the guide hole 21 in a portion lower than the fuel accumulation chamber 26 in the drawing to form a gap, etc.

The shaft portion 7c has an outer diameter slightly smaller than that of the sliding portion 7a, to secure an annular gap between an inner circumferential surface of the guide hole 21 and an outer circumferential surface of the shaft portion 7c (the gap is referred to as a fuel passage 27). As shown in FIG. 1, a leading end portion of the shaft portion 7c is provided with a seat line 28, which seats on the seat surface 24 in a valve-closing time of the needle 7, a first conical surface 29 at an upstream side of the seat line 28, and a second conical surface 30 at a downstream side of the seat line 28.

The first conical surface 29 forms an orifice between the seat surface 24 and itself at the upstream side of the seat line 28, with a cone angle slightly smaller than a seat angle (spread angle) of the seat surface 24 so that the orifice is gradually narrowed as going downstream. Specifically, an angle difference α1 between the seat surface 24 and the first conical surface 29 is set in a range of 0 degree<α1≦1 degree.

The second conical surface 30 forms an orifice between the seat surface 24 and itself at the downstream side of the seat line 28, with a cone angle slightly larger than the seat angle of the seat surface 24 so that the orifice is gradually widened as going downstream. Specifically, an angle difference α2 between the seat surface 24 and the second conical surface 30 Is set in a range of 0 degree<α2≦1 degree.

The leading end portion of the shaft portion 7c is provided with a notch 31 in a range originated at an origin A, which is at an upstream end of the first conical surface 29, to face the seat surface 24. The notch 31 is formed, for example, by removing an circumference of the shaft portion 7c in a stepped fashion to provide a cylindrical portion 7d with an outer diameter smaller than that of the shaft portion 7c at the upstream side (upper side in the drawing) of the first conical surface 29, as shown in FIG. 1.

An outer diameter D1 of the seat line 28 and an outer diameter D2 of the upstream end of the first conical surface 29, which is the origin A, satisfy the following relation (1):
D1≦D2≦D1+0.2 mm (1)

An inner diameter D3 of the inlet of the sac chamber 25 and the downstream end outer diameter D4 of the second conical surface 30 satisfy the following relation (2):
D3≦D4≦D3+0.1 mm (2)

Next, an action of the injector 2 is described.

When the solenoid 20 of the electromagnetic valve 5 is energized, the armature 18 is attracted by an electromagnet, so that the valve element 17 opens the outlet orifice. Thus, the fuel in the control chamber 12 flows through the outlet orifice and is discharged from the discharge passage 14 to a low-pressure side (a fuel tank, for example). Accordingly, the fuel pressure in the control chamber 12 decreases. When a hydraulic force to push up the needle 7 to a valve-opening side exceeds a force to urge the needle 7 to the valve-closing side ((Fuel pressure in control chamber 12 acting on upper end surface of control piston 4)+(Urging force of spring 8)), the needle 7 is lifted upward. As a result, the fuel flows from the fuel passage 27 through a gap between the seat line 28 and the seat surface 24 into the sac chamber 25, and is injected from the injection hole 23 into a cylinder of a diesel engine.

Then, the solenoid 20 stops being energized, to extinguish the attracting force of the electromagnet. Thus, the armature 18 is pushed back by the spring 19, so that the valve element 17 closes the outlet orifice to interrupt the communication between the control chamber 12 and the discharge passage 14. Accordingly, the fuel pressure in the control chamber 12 increases. When the force to urge the needle 7 to the valve-closing side exceeds the hydraulic force to push up the needle 7 to the valve-opening side, the needle 7 is pushed backward. As a result, the seat line 28 of the needle 7 seats on the seat surface 24, so that the communication between the fuel passage 27 and the sac chamber 25 is interrupted to stop the injection.

The nozzle 1 described in the first embodiment is provided with the notch 31 on the leading end portion of the needle 7, so that it is possible to locate the originating point of the orifice relative to the seat surface 24 closer to the seat line 28. That is, just after the needle 7 starts lifting up, the orifice is formed between the needle 7 and the seat surface 24 from the upstream end of the first conical surface 29, which is the origin A of the notch 31, to the seat line 28. Thus, the first conical surface 29 has such a pressure distribution that the pressure gradually decreases from the upstream end toward the seat line 28.

No orifice is formed between the notch 31 and the seat surface 24, so that the pressure distribution is constant on the upper end surface 31a of the notch 31 (the step surface that is formed between the shaft portion 7c and the cylindrical portion 7d), and high-pressure (the pressure of the high-pressure fuel supplied to the nozzle 1) acts on an entire of the upper end surface 31a.

Accordingly, as compared with a needle without the notch 31, the hydraulic force acting on the lower surface of the needle 7, that is, the hydraulic force to push up the needle 7 increases, so that it is possible to limit a change of an injection rate due to an abrasion of the seat line 28 or the seat surface 24.

Further, the angle difference α1 between the seat surface 24 and the first conical surface 29 is set to 1 degree or smaller, so that it is possible to decrease a surface pressure when the seat line 28 seats on the seat surface 24, to limit the abrasions of the seat line 28 and the abrasion of the seat surface 24.

In an analogous fashion, the angle difference α2 between the seat surface 24 and the second conical surface 30 is set to 1 degree or smaller, so that it is possible to decrease the surface pressure when the seat line 28 seats on the seat surface 24, to limit the abrasions of the seat line 28 and the abrasion of the seat surface 24. Further, by setting α2 to 1 degree or smaller, the pressure acting on the lower surface of the needle 7, that is, the hydraulic force to push up the needle 7 is less prone to be released, to limit the decrease of the hydraulic force.

Further, the first conical surface 29 is provided at the upstream side of the seat line 28, and the relation between the outer diameter D2 of the upstream end of the first conical surface 29 and the outer diameter D1 of the seat line 28 is set in accordance with the above-mentioned formula (1), so that it is possible to limit the abrasions of the seat line 28 and the seat surface 24 and to increase the hydraulic force acting on the notch 31.

Furthermore, the relation between the inner diameter D3 of the inlet of the sac chamber 25 and the downstream end outer diameter D4 of the second conical surface 30 is set in accordance with the above-mentioned formula (2), so that the pressure acting on the lower surface of the needle 7, that is, the hydraulic force to push up the needle 7 becomes prone to be released just after the lift start of the needle 7, to limit the decrease of the hydraulic force to push up the needle 7.

### Second Embodiment

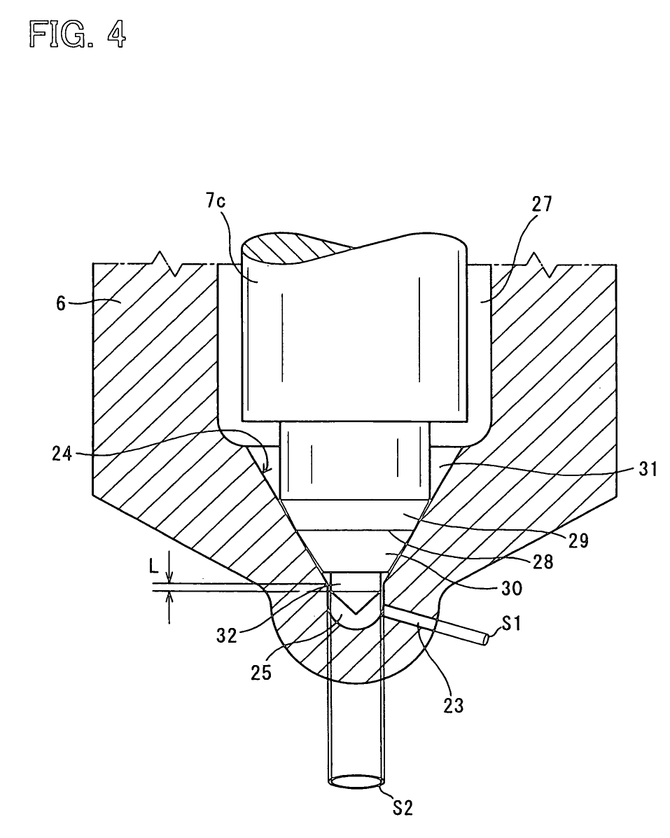

FIG. 4 is an enlarged cross-sectional view showing a leading end portion of the nozzle 1.

As shown in FIG. 4, the nozzle 1 according to the second embodiment is provided with a protruding portion 32 at a leading end of the needle 7 (at a downstream side of the second conical surface 30). When the seat line 28 seats on the seat surface 24, the protruding portion 32 is inserted in the sac chamber 25, to form an orifice therebetween.

Further, the protruding portion 32 does not come out of the sac chamber 25 even in a small lift time of the needle 7, which is smaller than a predetermined amount, so that a lap length L, i.e., a length in which the protruding portion 32 and the sac chamber 25 overlap each other in the axial direction to form the orifice, is set to be equivalent to the small lifting amount of the needle 7 or larger so as to maintain the orifice therebetween.

A minimum opening area SO generated between the seat line 28 and the seat surface 24 in the small lift time of the needle 7 and an entire opening area S1 of all the injection hole(s) 23 satisfy the following relation (3):
S0≦S1 (3)

Further, a gap area S2 formed between the protruding portion 32 and the sac chamber 25 when the protruding portion 32 is inserted in the sac chamber 25 satisfy the following relation (4):
S2≦S1 (4)

By the above-mentioned construction, the orifice is maintained between the protruding portion 32 and the sac chamber 25 at least until the needle 7 is lifted small, so that it is possible to limit a decrease of the hydraulic force to push up the needle 7 during the needle 7 is lifted small. Further, as in the first embodiment, by providing the notch 31 at the leading end portion of the needle 7, the hydraulic force to push up the needle 7 increases, to derive an effect to limit the change of the injection rate due to the abrasion of the seat line 28 or the seat surface 24.

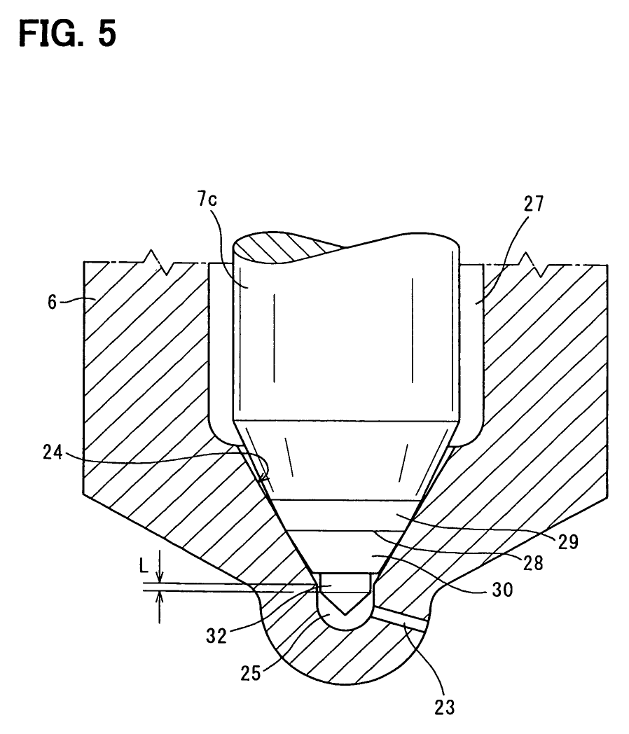

The construction shown in the second embodiment, that is, the construction that the protruding portion 32 is provided at the leading end of the needle 7 to form the orifice by inserting the protruding portion 32 in the sac chamber 25 can be applied to a nozzle that does not have the notch 31 at the leading end portion of the nozzle 7, as shown in FIG. 5.

This description of the invention is merely exemplary in nature and, thus, variations that do not depart from the gist of the invention are intended to be within the scope of the invention. Such variations are not to be regarded as a departure from the spirit and scope of the invention.

What is claimed is:

1. A fluid injection nozzle comprising:
a nozzle body that has a guide hole therein to extend in an axial direction thereof, a seat surface formed in a conical shape on a leading end portion of the guide hole, a sac chamber formed at a downstream side of the sac chamber and an injection hole opened to the sac chamber; and
a needle that is slidably inserted in the guide hole to open and close the injection hole,
wherein a leading end portion of the needle is provided with:
a first conical surface and a second conical surface that forms a seat line therebetween which comes in contact with the seat surface when the needle closes the injection hole, a gap between the first conical surface and the seat surface gradually narrowed as going toward the injection hole and a gap between the second conical surface and the seat surface gradually widened as going toward the injection hole; and
a notch that extends in the axial direction from an upstream end of the first conical surface to a side opposite from the second conical surface to face the seat surface.

2. The fluid injection nozzle according to claim 1, wherein a difference α1 between an angle of inclination of the seat surface and an angle of inclination of the first conical surface relative to the axial direction is set in a range of 0 degree<α1≦1 degree.

3. The fluid injection nozzle according to claim 1, wherein a difference α2 between an angle of inclination of the seat surface and the an angle of inclination of the second conical surface relative to the axial direction is set in a range of 0 degree<α2≦1 degree.

4. The fluid injection nozzle according to claim 1, wherein an outer diameter D1 of the seat line and an outer diameter D2 of the upstream end of the first conical surface satisfy the following relation:
D1≦D2≦D1+0.2 mm.

5. The fluid injection nozzle according to claim 1, wherein an inner diameter D3 of an inlet of the sac chamber and an outer diameter D4 of a downstream end of the second conical surface satisfy the following relation:
D3≦D4≦D3+0.1 mm.

6. A fluid injection nozzle comprising:
a nozzle body that has a guide hole therein to extend in an axial direction thereof, a seat surface formed in a conical shape on a leading end portion of the guide hole, a sac chamber formed at a downstream side of the sac chamber and an injection hole opened to the sac chamber; and
a needle that is slidably inserted in the guide hole to open and close the injection hole,
wherein in that a leading end portion of the needle is provided with:
a first conical surface and a second conical surface that form a seat line therebetween which comes in contact with the seat surface when the needle closes the injection hole, a gap between the first conical surface and the seat surface gradually narrowed as going toward the injection hole and a gap between the second conical surface and the seat surface gradually widened as going toward the injection hole; and
a protruding portion that is formed at a downstream side than the second conical surface to be inserted in the sac chamber to form an orifice therebetween when the seat line is in contact with the seat surface.

7. The fluid injection nozzle according to claim 6, wherein the protruding portion has a length in the axial direction to maintain the orifice while a lift of the needle is within a predetermined height.

8. The fluid injection nozzle according to claim 6, wherein an opening area S1 of the injection hole and a cross-sectional area S2 of a gap between the protruding portion and the sac chamber when the protruding portion is inserted in the sac chamber satisfy the following relation:
S2≦S1.

9. The fluid injection nozzle according to claim 1, wherein the needle is provided with a protruding portion at a downstream side than the second conical surface to be inserted in the sac chamber to form an orifice therebetween when the seat line is in contact with the seat surface.

10. The fluid injection nozzle according to claim 9, wherein the protruding portion has a length in the axial direction to maintain the orifice while a lift of the needle is within a predetermined height.

11. The fluid injection nozzle according to claim 9, wherein an opening area Si of the injection hole and a cross-sectional area of a gap between the protruding portion and the sac chamber when the protruding portion is inserted in the sac chamber satisfy the following relation:
S2≦S1.
